(19) United States
(12) Patent Application Publication
(10) Pub. No.: US 2007/0259704 A1
(43) Pub. Date: Nov. 8, 2007

(54) Mobile phone receiving bag for shielding electromagnetic wave

(76) Inventor: Shiou-Jen Jung, Taoyuan Hsien (TW)

Correspondence Address: SHIOU-JEN JUNG, 235 Chung-Ho, Box 8-24, Taipei, TW

(21) Appl. No.: 11/429,360

(22) Filed: May 8, 2006

(51) Int. Cl. H04M 1/00

(52) U.S. Cl. 455/575.8

(57) ABSTRACT

A mobile phone receiving bag severs for shielding electromagnetic wave. The mobile bag receiving bag comprises a receiving bag having a hollow space for receiving a mobile phone; a shield unit installed at one lateral surface of the receiving bag at a position adjacent to a user's waist as it is worn the receiving bag on the waist. The shield unit is selected from one of metal fibers, conductive materials or other material having functions of absorbing or decaying or shielding electromagnetic waves. The shielding unit is integrally or separately formed with the receiving bag. An earphone bag is further added to the receiving bag. The earphone bag is separable from the receiving bag; strong magnets or fastener tapes or buckles are installed to the earphone bag and receiving bag so that the earphone bag and receiving bag are attractable to one another.

### FIELD OF THE INVENTION

The present invention relates to handset shielding devices, and particularly to a mobile phone receiving bag for shielding electromagnetic wave so as to reduce the harmfulness to the human body.

### BACKGROUND OF THE INVENTION

Currently, people have known that many electronic devices will emit electromagnetic waves. However electromagnetic wave is dangerous to human health. The high intensity electromagnetic waves will affect the normal function of the chromosomes and DNAs

It is known that the mobile phone can emit strong electromagnetic wave which is harmful to human life. For an improvement, hand free earphones are developed so as to reduce the harmfulness of the handset to the human brain. However it still threats the human body, such as the organs within the waist since it is often that the earphone is suspended on the waist of the user.

### SUMMARY OF THE INVENTION

Accordingly, the primary object of the present invention is to provide a mobile phone receiving bag for shielding electromagnetic wave so as to reduce the harmfulness to the human body.

To achieve above object, the present invention provides a mobile phone receiving bag for shielding electromagnetic wave. The mobile bag receiving bag comprises a receiving bag having a hollow space for receiving a mobile phone; a shield unit installed at one lateral surface of the receiving bag at a position adjacent to a user's waist as it is worn the receiving bag on the waist. The shield unit is selected from one of metal fibers, conductive materials or other material having functions of absorbing or decaying or shielding electromagnetic waves. The shielding unit is integrally or separately formed with the receiving bag. An earphone bag is further added to the receiving bag. The earphone bag is separable from the receiving bag; a strong magnet or a fastener tape is installed to the earphone bag; and a second strong magnet or fastener tape is installed at the receiving bag so the earphone bag and receiving bag are attractable to one another.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a structural schematic view of the present invention.

FIG. 3 is an exploded perspective view of the second embodiment of the present invention.

FIG. 4 is a perspective view about the second embodiment of the present invention.

FIG. 5 is a perspective view of a third embodiment of the present invention.

FIG. 6 is a lateral schematic view about a third embodiment of the present invention.

FIG. 7 shows the application of the third embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

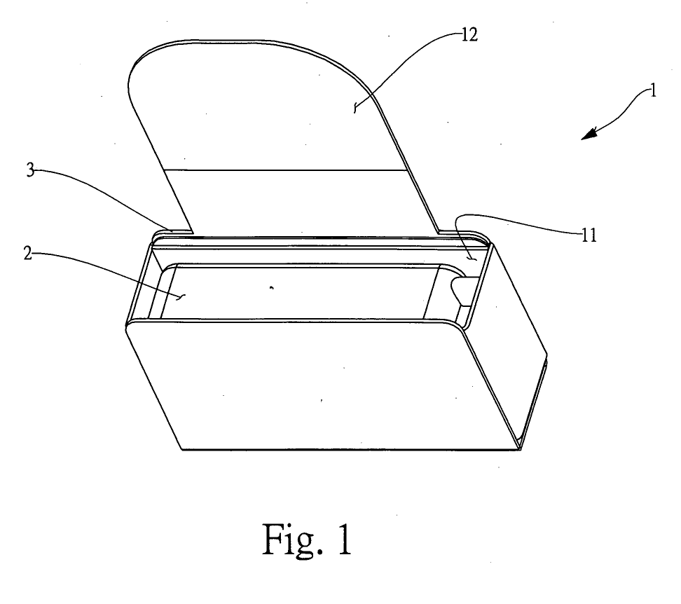

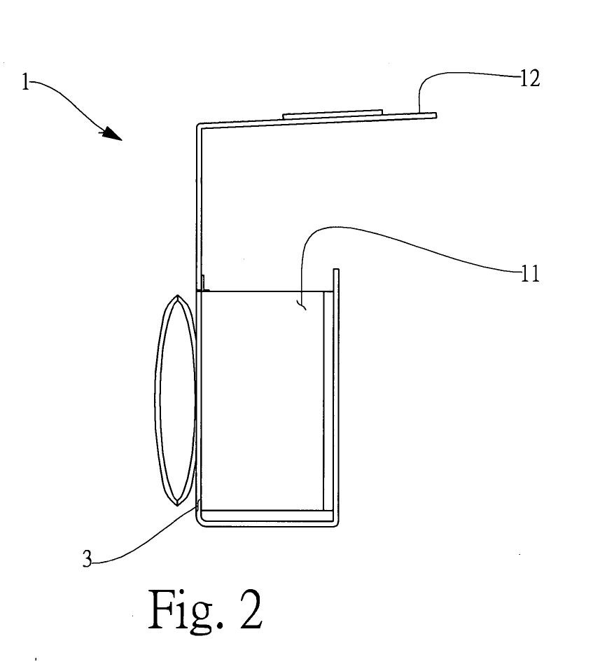

Referring to FIGS. 1, and 2, the mobile phone receiving bag for shielding electromagnetic wave of the present invention is illustrated. The receiving bag has a hollow space 11 for receiving a mobile phone 2. The receiving bag 1 is further installed with an upper cover layer 12. The upper cover layer 12 is folded downwards to protect the mobile phone 2 not to fall out of the hollow space. In the present invention, one lateral surface of the receiving bag 1 adjacent to the use's waist as it is worn is installed with a shielding unit 3. The shield unit 3 may be one of metal fibers, metal nets, conductive cloth, conductive coating layers, such as conductive paints, electroplating layers, nanometer carbon coating layers, etc. or other conductive material for absorbing or decaying or shielding electromagnetic waves. The shielding unit 3 may be formed with the receiving bag 3 integrally or separately. Thereby, the electromagnetic waves from the mobile phone in the receiving bag can be shielded, isolated or absorbed by the shielding unit 3. Thus the electromagnetic wave will not affect the health of the users.

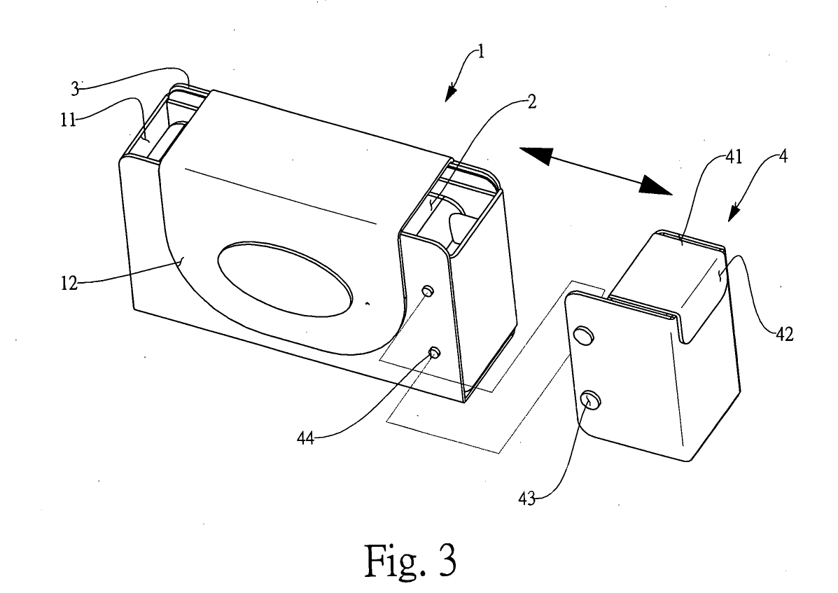

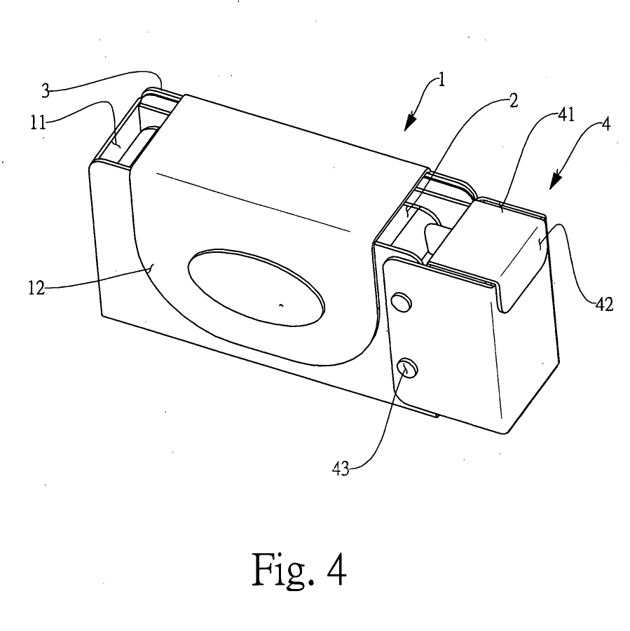

Referring to FIGS. 3 and 4, in the present invention, an earphone bag 4 is further added. The earphone bag 4 can be fixed to or separably adhered to one lateral side of the receiving bag 1. For example, a strong magnet 44 can be installed to the receiving bag 4. A further strong magnet 43 is positioned on the corresponding location of the earphone bag 4. By using the strong magnet between the strong magnets 43 and 44, the earphone bag 4 is connected to the receiving bag 1 (the strong magnet is changeable by a buckle, a fastener tape or a fastener cloth; the earphone bag is capable of attaching to different locations of the receiving bag, such as on the top of the receiving bag, a bottom of the receiving bag or any other lateral side of the receiving bag.) The earphone bag 4 has a receiving space 41 and a cover layer 42. A receiving bag 1 of prior arts is only capable of receiving a mobile phone, causing that the peripheral device of the mobile phone, such as a wired hand free earphone or a bluetooth earphone, has not specific space to receive it.

Many users put the earphone into their pocket and then were bothered because of difficulty in finding or reaching their earphone while their mobile phone is ringing. The present invention has the earphone bag 4 installed beside the receiving bag 1. Users can take the mobile phone 2 and earphone easily and conveniently. The present invention is quite convenient and ideally practical for users

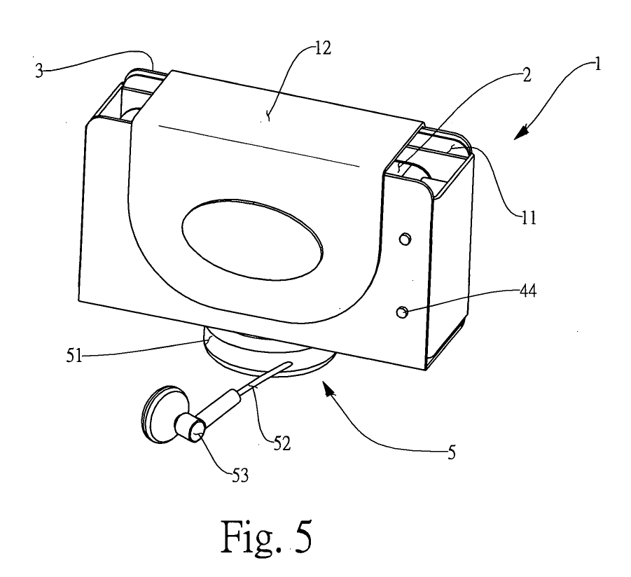

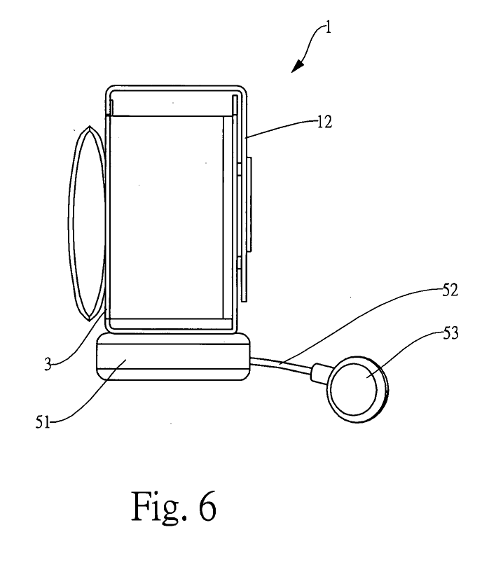

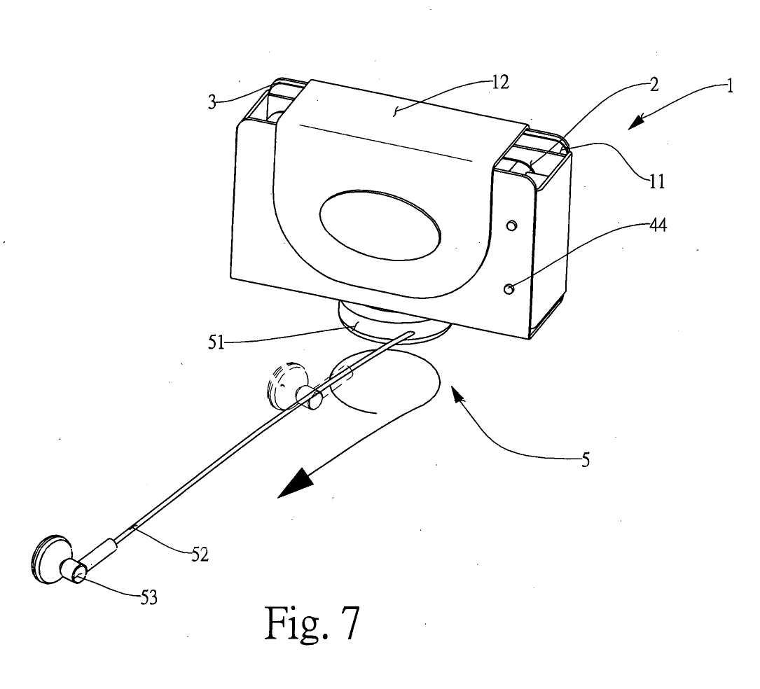

Referring to FIGS. 5 and 6, the receiving bag 1 of the present invention is available to be positioned on a suitable location, such as the bottom of the receiving bag 1 or any other suitable location. Furthermore, an earphone wire winding device 5 is installed on the present invention. The earphone wire winding device 5 has an auto wire winding disk 51, an earphone wire 52 and an earphone 53. Referring to FIG. 5, when the earphone 53 is not used, the auto wire winding disk 51 is capable of winding the wire of the earphone wire 52 for storage. When the earphone 53 is used, users need only to pull the earphone wire 52 and earphone 53 out, referring to FIG. 7, so that the earphone wire 52 gets out of the auto wire winding disk 51 in use. It is quite convenient and ideal.

According to the FIG. 3 and FIG. 5 of the present invention, the present invention is not only for the receiving function of the earphone. As the above-mentioned, electromagnetic wave is dangerous to human body, the receiving bag 1 of the present invention is only added with the shielding unit 3. The shielding unit 3 is assured to have the function of shielding electromagnetic wave when the mobile phone 2 is retained in the receiving bag 1. However, when a user is getting a phone call by the mobile phone 2 without using hand free earphone, the user's brain is still threaten by electromagnetic wave. Therefore, the present invention is considered to form a proper position for receiving an earphone. The embodiments in FIG. 3 and FIG. 5 provide novel types so that a user is able to use a hand free earphone conveniently as a phone call is inputted through the mobile phone 2. The way of the present invention is capable of reducing the threat of electromagnetic wave to the human body.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A mobile phone receiving bag for shielding electromagnetic wave comprising:
a receiving bag having a hollow space for receiving a mobile phone;
a shield unit installed at one lateral surface of the receiving bag at a position adjacent to a user's waist as it is worn the receiving bag on the waist;
wherein the shield unit is selected from one of metal fibers, conductive materials or other material having functions of absorbing or decaying or shielding electromagnetic waves.

2. The mobile phone receiving bag for shielding electromagnetic wave as claimed in claim 1, wherein the shielding unit is integrally formed with the receiving bag.

3. The mobile phone receiving bag for shielding electromagnetic wave as claimed in claim 1, wherein the shielding unit is externally attached to the structure of the receiving bag.

4. The mobile phone receiving bag for shielding electromagnetic wave as claimed in claim 1, wherein an earphone bag is further added to the receiving bag.

5. The mobile phone receiving bag for shielding electromagnetic wave as claimed in claim 4, wherein the earphone bag is separable from the receiving bag; a strong magnet is installed to the earphone bag; and a second strong magnet is installed at the receiving bag so the earphone bag and receiving bag are attractable to one another.

6. The mobile phone receiving bag for shielding electromagnetic wave as claimed in claim 4, wherein the earphone bag is installed integrally on the receiving bag.

7. The mobile phone receiving bag for shielding electromagnetic wave as claimed in claim 1, wherein the receiving bag is installed with an earphone wire winding device; and the earphone wire winding device includes an auto wire winding disk, an earphone wire and an earphone.

8. The mobile phone receiving bag for shielding electromagnetic wave as claimed in claim 7, wherein the earphone wire winding device is installed on a bottom of the receiving bag.

9. The mobile phone receiving bag for shielding electromagnetic wave as claimed in claim 4, wherein the earphone bag is separable from the receiving bag; a buckle is installed to the earphone bag; and a second buckle is installed at the receiving bag so the earphone bag and receiving bag are combinable to one another.

10. The mobile phone receiving bag for shielding electromagnetic wave as claimed in claim 4, wherein the earphone bag is separable from the receiving bag; a fastener tape is installed to the earphone bag; and a second fastener tape is installed at the receiving bag so the earphone bag and receiving bag are adhesive to one another.
